(19) United States
(12) Patent Application Publication
(10) Pub. No.: US 2003/0160898 A1
(43) Pub. Date: Aug. 28, 2003

(54) Digital TV, image service system using the same and method thereof

(76) Inventors: Lee Hyun Baek, Goyang-si (KR); Chang Su Kim, Suwon-si (KR)

Correspondence Address: HARNESS, DICKEY & PIERCE, P.L.C., P.O. BOX 8910, RESTON, VA, 20195, US

(21) Appl. No.: 10/372,085

(22) Filed: Feb. 25, 2003

(30) Foreign Application Priority Data
Feb. 27, 2002 (KR) P 2002-10588

(51) Int. Cl. H04N 5/44

(52) U.S. Cl. 348/552

(57) ABSTRACT

Disclosed are a digital TV, an image service system using the same and a method thereof. The present invention includes a memory storing images received externally, a wireless communication module transmitting the images stored in the memory by wireless to an external device, or the wireless communication module receiving the images transmitted from the external device to transmit to the memory, and a controller controlling image transmission/reception of the wireless communication module.

This application claims the benefit of the Korean Application No. P2002-10588 filed on Feb. 27, 2002, which is hereby incorporated by reference.

### BACKGROUND OF THE INVENTION

1. Field of the Invention

The present invention relates to a digital TV, an image service system using the same and a method thereof.

2. Discussion of the Related Art

Recently, as supply of digital cameras increases, so does the population making use of such devices.

A user generates image data using a digital camera, and then views an image through a small display device (LCD) installed directly at the camera or transmits to display the image to a PC or an electronic frame which is developed to market by some manufacturers.

A connection between the digital camera and the PC is accomplished using USB (universal serial bus).

Reading, writing, editing, and displaying of the image inputted from the digital camera are performed by the PC.

Moreover, when a client transmits a digital image using Internet, there are some companies printing the digital image on an exclusive photographic paper to deliver.

In providing such services, the overall works are almost carried out through the client's PC connected to Internet.

### SUMMARY OF THE INVENTION

Accordingly, the present invention is directed to a digital TV, an image service system using the same and a method thereof that substantially obviate one or more problems due to limitations and disadvantages of the related art.

An object of the present invention is to provide a digital TV, an image service system using the same and a method thereof enabling to receive a demanding image service variously and conveniently by transmitting/receiving an image and the like by wireless.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital TV according to the present invention includes a memory storing images received externally, a wireless communication module transmitting the images stored in the memory by wireless to an external device, or the wireless communication module receiving the images transmitted from the external device to transmit to the memory, and a controller controlling image transmission/reception of the wireless communication module.

Preferably, the wireless communication module is a Bluetooth module.

Preferably, the image stored in the memory is the image received from the wireless communication module or an image selected from broadcast signals of the digital TV.

Preferably, the external device is selected from the group consisting of a digital camera, a camcorder, a mobile phone, and a PDA (personal digital assistant).

Preferably, the external device has a wireless communication module enabling to transmit/receive data to/from the digital TV.

In another aspect of the present invention, an image service system using a digital TV includes a digital TV having a wireless communication module, an external device transmit/receive a selected image to/from the digital TV, and an image service provider receiving the selected image through the external device to provide a corresponding image service.

Preferably, the digital TV includes a memory storing images received externally, a wireless communication module transmitting the images stored in the memory by wireless to an external device, or the wireless communication module receiving the images transmitted from the external device to transmit to the memory, and a controller controlling image transmission/reception of the wireless communication module.

More preferably, the wireless communication module is a Bluetooth module.

More preferably, the image stored in the memory is the image received from the wireless communication module or an image selected from broadcast signals of the digital TV.

Preferably, the external device is selected from the group consisting of a digital camera, a camcorder, a mobile phone, and a PDA (personal digital assistant).

Preferably, the external device has a wireless communication module enabling to transmit/receive data to/from the digital TV.

In a further aspect of the present invention, an image service method using a digital TV having a wireless communication module includes the steps of storing images in the digital TV, displaying the stored images, selecting a demanded image from the displayed images, selecting an external device to which the selected image will be transmitted, transmitting the selected image to the selected external device through a wireless communication module of the digital TV, and transmitting the transmitted image to an image service provider through the selected external device to be provided with a demanded service.

Preferably, the step of storing the images in the digital TV includes the steps of judging whether there exists an input signal for searching the external device from a user or an input signal for image transmission from the external device, connecting the digital TV and the external device to each other by wireless if there exists the input signal, transmitting an information of the external device and an image list information stored in the external device to the digital TV through the wireless communication module of the digital TV, displaying an image list of the received image list information, judging whether there is an input signal for image transmission from the user, storing an image of the external device in the digital TV if there is the input signal for the image transmission, and releasing wireless connection between the digital TV and the external device.

More preferably, the digital TV is at a standby mode if the input signal for searching the external device or for the image transmission fails to exist.

More preferably, the step of displaying the received image list is repeated if the input signal for the image transmission fails to exist.

More preferably, the external device has a wireless communication module and is selected from the group consisting of a digital camera, a camcorder, a mobile phone, and a PDA (personal digital assistant).

Preferably, the external device that will transmit the selected image is selected from the group consisting of a digital camera, a camcorder, a mobile phone, and a PDA (personal digital assistant).

Preferably, the step of transmitting the selected image to the selected external device through the wireless communication module of the digital TV includes the steps of judging whether an input signal for image transmission exists from a user or not, connecting the digital TV and the external device to each other by wireless if there exists the input signal for the image transmission, transmitting the image stored in the digital TV to the external device through the wireless communication module of the digital TV, judging whether the image transmission is completed or not, and releasing a wireless connection between the digital TV and the external device if the image transmission is completed.

More preferably, the step of displaying the stored images is repeated if the input signal for the image transmission fails to exist.

More preferably, the step of transmitting the image to the external device is repeated if the image transmission is not completed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block diagram of a digital TV according to the present invention;

FIG. 2A and FIG. 2B illustrate flowcharts for explaining an image service method using a digital TV according to the present invention, respectively;

FIG. 3 illustrates a diagram of a method of transmitting an image by wireless to a digital TV according to the present invention; and

FIG. 4 and FIG. 5 illustrate diagrams of an image service system using a digital TV according to the present invention, respectively.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

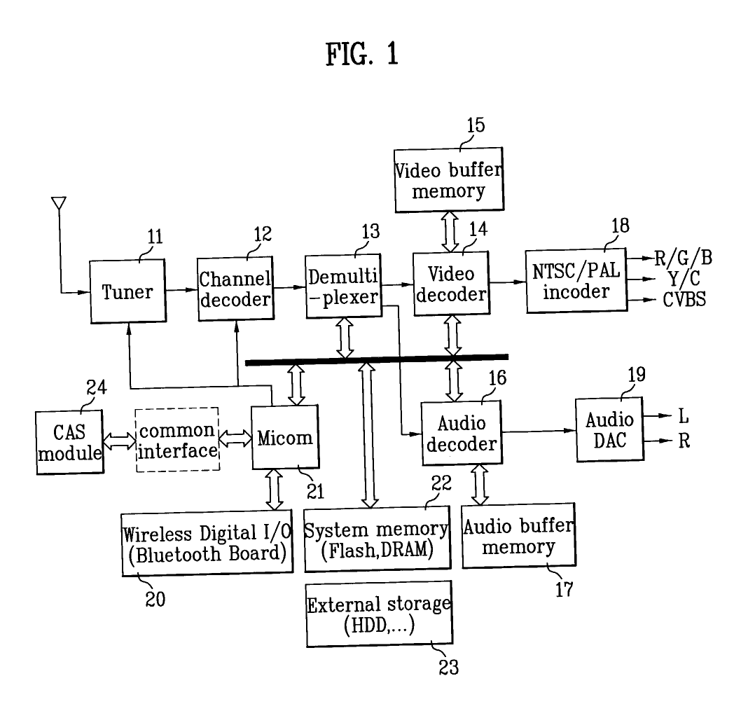

FIG. 1 illustrates a block diagram of a digital TV according to the present invention.

Referring to FIG. 1, a digital TV according to the present invention includes a tuner unit 11 receiving a digital broadcast signal, a channel decoder 12 decoding the digital broadcast signal received by the tuner unit 11 by each channel, a demultiplexer 13 separating a composite signal according to each of the channels from the channel decoder 12, a video decoder 14 decoding a video signal separated through the demultiplexer 13, a buffer memory unit 15 storing the video signal temporarily, an audio decoder 16 decoding an audio signal separated through the demultiplexer 13, and an audio buffer memory unit 17 storing the audio signal temporarily.

The decoded video signal is encoded by an NTSC/PAL encoder 18 to be outputted as a digital RGB (red, green, blue) signal, a brightness/color difference signal Y/C, and a composite video signal CVBS. And, the audio signal decoded by the audio decoder 16 is outputted to an audio DAC 19.

Moreover, the above-constituted digital TV includes a wireless digital I/O (ex. Bluetooth board) 20 having a Bluetooth module) in wireless communication modules for wireless interfacing with external devices.

Namely, the digital TV transmits/receives images to/from an external portable device (ex. mobile phone, etc.) through the wireless digital I/O 20.

In this case, the wireless digital I/O 20 is connected to the digital TV through an interface.

Besides, the image transmission/reception between the wireless digital I/O 20 and the external portable device is controlled by a control unit (microcomputer) 21 inside the digital TV.

A demanded portion of the broadcast signals received in the digital TV is captured into a block of the video block 14 through the control unit 21.

In this case, the captured image is compressed using JPEG algorithm to be stored in storage units 22 and 23, and is then decoded to display on outputting images.

Moreover, the image received by the wireless digital I/O 20 or the image captured by the digital TV itself is stored in the system memory 22 or the external memory device 23.

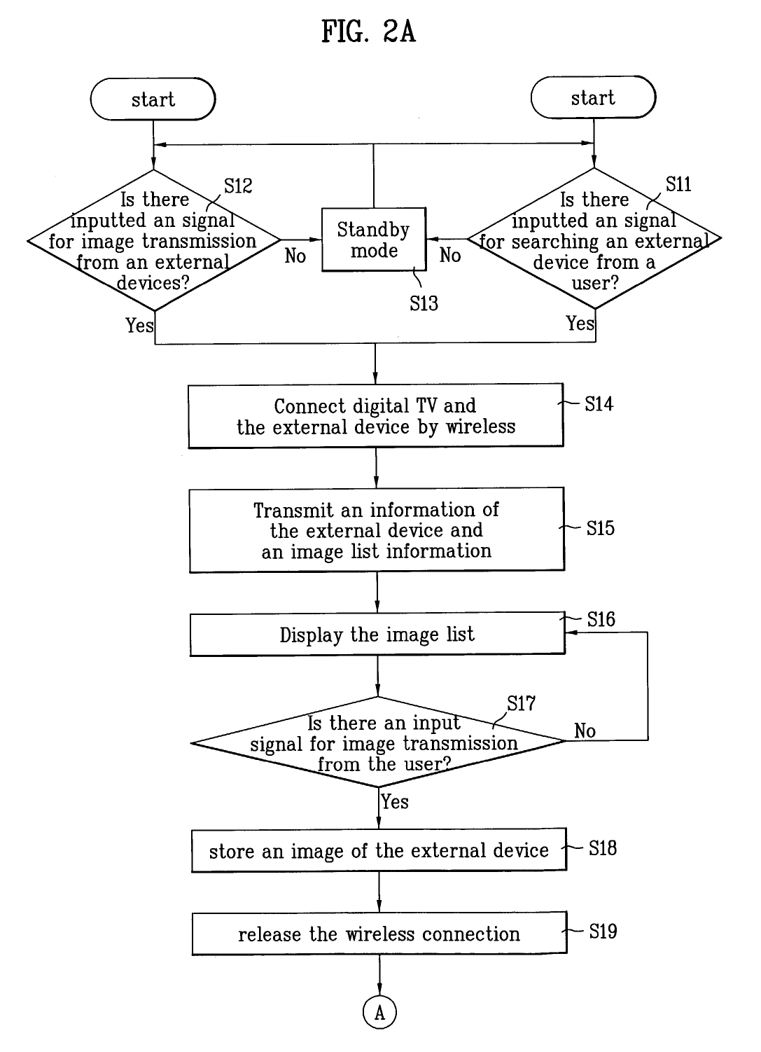

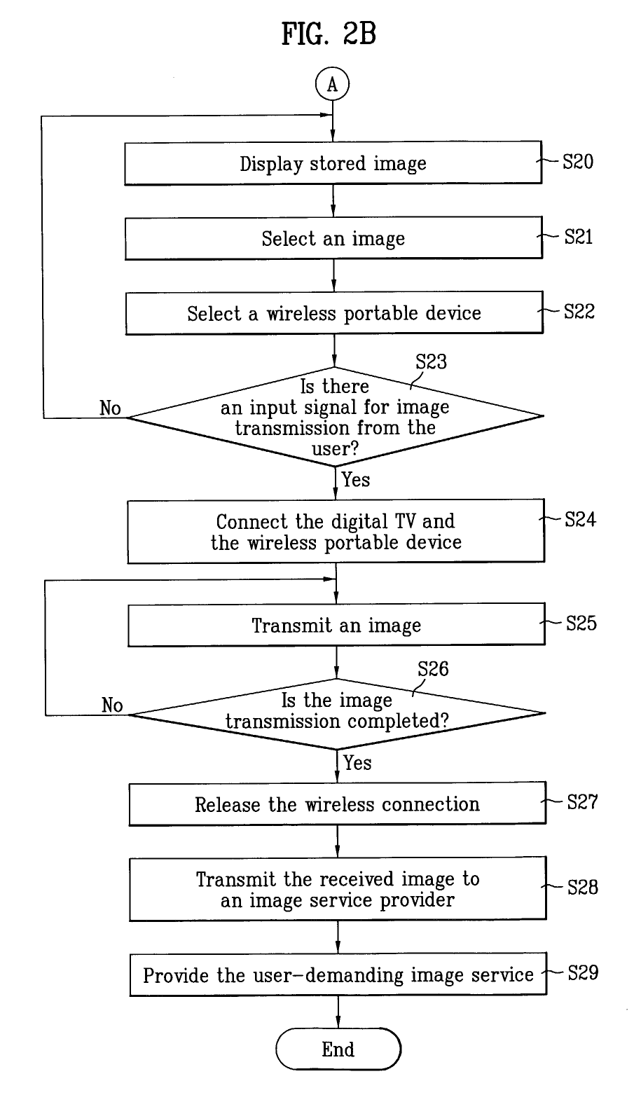

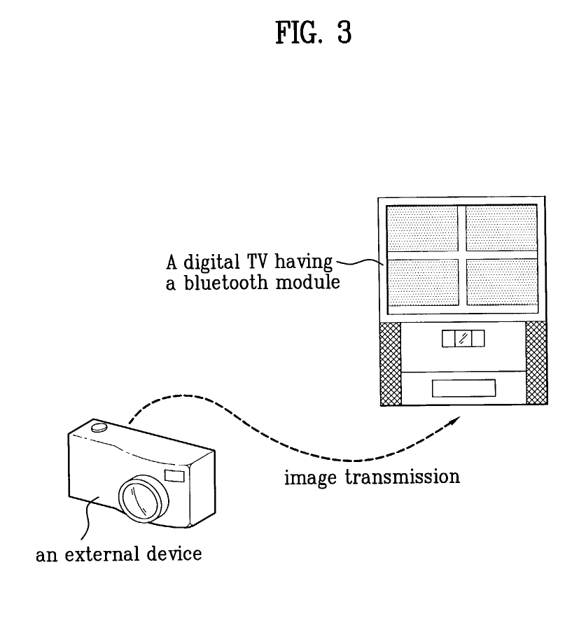

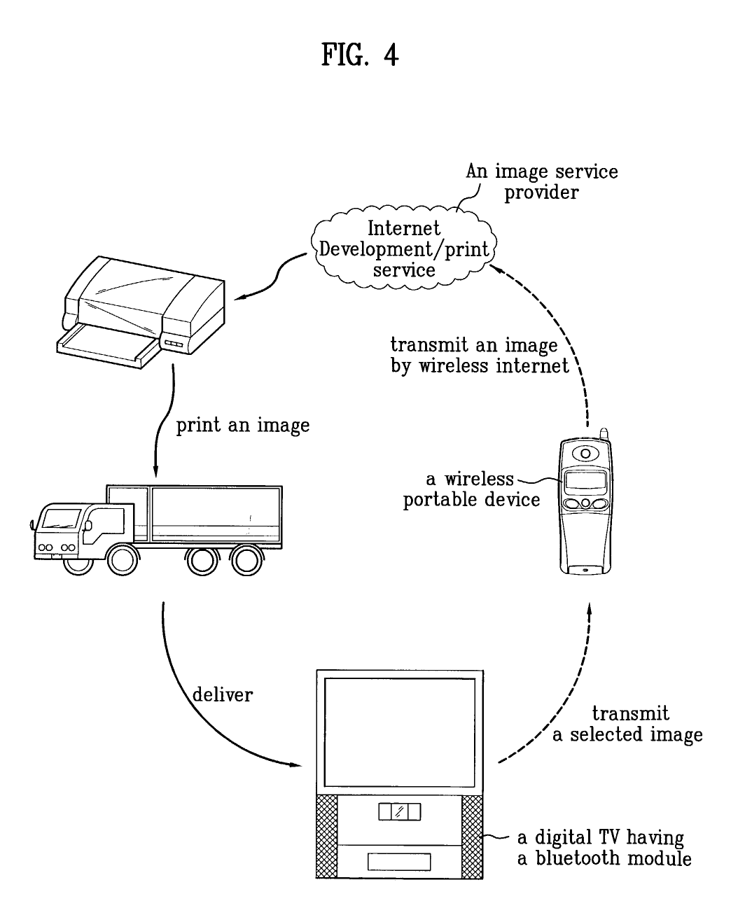

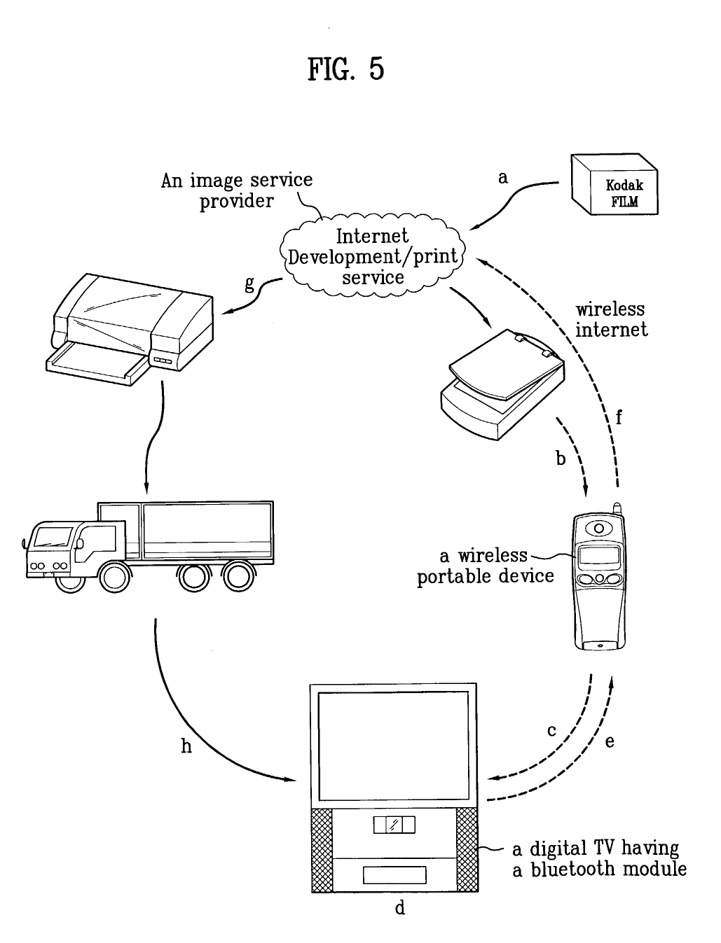

FIG. 2A and FIG. 2B illustrate flowcharts for explaining an image service method using a digital TV according to the present invention, respectively, FIG. 3 illustrates a diagram of a method of transmitting an image by wireless to a digital TV according to the present invention, and FIG. 4 and FIG. 5 illustrate diagrams of an image service system using a digital TV according to the present invention, respectively.

Referring to FIG. 4 and FIG. 5, an image service system according to the present invention includes a memory storing images received from an outside, a wireless communication module receiving to transmit the images stored in the memory to the outside by wireless or receiving the images transmitted from the outside to transmit to the memory, a digital TV including a controller controlling image transmission/reception of the wireless digital I/O, a wireless portable device transmitting/receiving by wireless the image selected through the wireless digital I/O of the digital TV, and an image service provider receiving the selected image through the wireless portable device to provide a corresponding image service.

In this case, the wireless communication module is a Bluetooth module.

Moreover, the image stored in the memory may be the image received from the wireless communication module or the image selected from broadcast signals of the digital TV.

And, the wireless portable device may be a device having a wireless communication module enabling to transmit/receive data to/from the digital TV such as a mobile phone, PDA (personal digital assistant), etc. And, the external device, as shown in FIG. 3, enabling to transmit the image to the digital TV may be a digital camera, a camcorder, and the like.

An image service method of the above-constituted present invention is described as follows.

Referring to FIG. 2A, FIG. 2B, and FIG. 3, it is judged whether an input signal for searching an external device such as a digital camera, a camcorder, or the like exists from a user (S11) or whether an input signal for image transmission exists from an external device or not (S12).

If there exists no input signal, a digital TV is left at a standby mode (S13). If there exists the input signal, the digital TV and the external device are connected to each other by wireless through a Bluetooth module (S14).

Subsequently, information of the external device and imaqe list information stored in the external device are transmitted to the digital TV through the Bluetooth module of the digital TV (S15).

The digital TV then displays the received image list (S16).

In this case, the user enables to delete the image that is unnecessary. Besides, the user enables to select several kinds of the images to display them simultaneously or enables to display the selected images one by one like a slide show.

And, it is judged whether there exists an input signal for image transmission from the user (S17).

If there is no input signal for the image transmission, the received image list is kept being displayed (S16). If there exists the input signal for the image transmission, the image of the external device is stored in the digital TV (S18).

And, the wireless connection between the digital TV and the external device is released (S19).

Subsequently, if the user-demanding service is provided, the images stored in the digital TV are displayed (S20).

The user then selects the demanded one of the displayed images (S21), and selects a wireless portable device such as a mobile phone, a PDA (personal digital assistant), and the like to transmit the selected image (S22).

And, the digital TV judges whether there is an input signal for image transmission from the user (S23).

If there is no input signal for the image transmission, the stored images are kept being displayed (S20). If there exists the input signal for the image transmission, the digital TV and the wireless portable device are connected to each other through a Bluetooth module (S24).

Subsequently, the image stored in the digital TV, as shown in FIG. 4, is transmitted to the wireless portable device through the Bluetooth module of the digital TV (S25). And, the digital TV judges whether the image transmission is completed (S26).

If the image transmission fails to be completed, the image is transmitted to the wireless portable device continuously (S25). If the image transmission is completed, the wireless connection between the digital TV and the wireless portable device is released (S27).

Finally, the wireless portable device transmits the received image to an image service provider (S28), and the image service provider provides the user-demanding image service (S29).

Thus, the user can be provided with various services using the above-explained method.

First of all, the digital TV according to the present invention, as shown in FIG. 3, receives the image from the external device (digital camera, camcorder, mobile phone, etc.) through the Bluetooth module to store therein. And, the diaital TV according to the present invention enables to store the demanded image from the broadcast signals in the memory by frame unit.

The stored images can be used as an electronic frame or the like in accordance with a user's request.

Meanwhile, the user-selecting images from the images (images inputted from the digital camera and the like or the broadcast images captured by the digital TV itself) stored in the digital TV, as shown in FIG. 4, are transmitted to the wireless portable device through the Bluetooth module.

The transmitted images are provided to the image service provider through wireless Internet, and the image service provider develops and prints the image to deliver the outputted image to the user.

Hence, the user can be provided with the image developing & printing services by the image service provider.

Moreover, a film photographed by a conventional camera, as shown in FIG. 5, is transmitted to an image service provider providing Internet developing & printing services (a).

After developing the film, the image service provider generates a digital image using a film scanner to transmit to the portable device of the user using the wireless Internet (b).

The transmitted image is temporarily stored in the portable device of the user.

The user transmits the images from the portable device to the digital TV using the Bluetooth module (c). Then, the user checks the images on the digital TV and selects the user-demanding images (d).

Subsequently, the user transmits image selection information to the portable device through the Bluetooth module again (e), and transmits the image selection information to the image service provider providing the Internet developing & printing services using the wireless Internet through the portable device (f).

Meanwhile, the image service provider outputs the user-selecting images using a printer of high quality or the like (g) to deliver to the user (h).

As explained in the above description, the present invention transmits the image by wireless from the external device to the digital TV or from the digital TV to the external device through the Bluetooth module, thereby enabling the user to be provided with the various and convenient image services.

Namely, using the digital TV and the portable device, the user facilitates to attain the demanded picture outputs from the image service provider conveniently without the expensive PC, the printer enabling the picture outputs of high quality, and the like.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A digital TV comprising:
a memory storing images received externally;
a wireless communication module transmitting the images stored in the memory by wireless to an external device, or the wireless communication module receiving the images transmitted from the external device to transmit to the memory; and
a controller controlling image transmission/reception of the wireless communication module.

2. The digital TV of claim 1, wherein the wireless communication module is a Bluetooth module.

3. The digital TV of claim 1, wherein the image stored in the memory is the image received from the wireless communication module or an image selected from broadcast signals of the digital TV.

4. The digital TV of claim 1, wherein the external device is selected from the group consisting of a digital camera, a camcorder, a mobile phone, and a PDA (personal digital assistant).

5. The digital TV of claim 1, wherein the external device has a wireless communication module enabling to transmit/receive data to/from the digital TV.

6. An image service system using a digital TV, comprising:
a digital TV having a wireless communication module;
an external device transmit/receive a selected image to/from the digital TV; and
an image service provider receiving the selected image through the external device to provide a corresponding image service.

7. The image service system using the digital TV of claim 6, the digital TV comprising:
a memory storing images received externally;
a wireless communication module transmitting the images stored in the memory by wireless to an external device, or the wireless communication module receiving the images transmitted from the external device to transmit to the memory; and
a controller controlling image transmission/reception of the wireless communication module.

8. The image service system using the digital TV of claim 7, wherein the wireless communication module is a Bluetooth module.

9. The image service system using the digital TV of claim 7, wherein the image stored in the memory is the image received from the wireless communication module or an image selected from broadcast signals of the digital TV.

10. The image service system using the digital TV of claim 6, wherein the external device is selected from the group consisting of a digital camera, a camcorder, a mobile phone, and a PDA (personal digital assistant).

11. The image service system using the digital TV of claim 6, wherein the external device has a wireless communication module enabling to transmit/receive data to/from the digital TV.

12. An image service method using a digital TV, the digital TV having a wireless communication module, the image service method comprising the steps of:
storing images in the digital TV;
displaying the stored images;
selecting a demanded image from the displayed images;
selecting an external device to which the selected image will be transmitted;
transmitting the selected image to the selected external device through a wireless communication module of the digital TV; and
transmitting the transmitted image to an image service provider through the selected external device to be provided with a demanded service.

13. The image service method of claim 12, the step of storing the images in the digital TV, comprising the steps of:
judging whether there exists an input signal for searching the external device from a user or an input signal for image transmission from the external device;
connecting the digital TV and the external device to each other by wireless if there exists the input signal;
transmitting an information of the external device and an image list information stored in the external device to the digital TV through the wireless communication module of the digital TV;
displaying an image list of the received image list information;
judging whether there is an input signal for image transmission from the user;
storing an image of the external device in the digital TV if there is the input signal for the image transmission; and
releasing wireless connection between the digital TV and the external device.

14. The image service method of claim 13, wherein the digital TV is at a standby mode if the input signal for searching the external device or for the image transmission fails to exist.

15. The image service method of claim 13, wherein the step of displaying the received image list is repeated if the input signal for the image transmission fails to exist.

16. The image service method of claim 13, wherein the external device has a wireless communication module and is selected from the group consisting of a digital camera, a camcorder, a mobile phone, and a PDA (personal digital assistant).

17. The image service method of claim 12, wherein the external device that will transmit the selected image is selected from the group consisting of a digital camera, a camcorder, a mobile phone, and a PDA (personal digital assistant).

18. The image service method of claim 12, the step of transmitting the selected image to the selected external device through the wireless communication module of the digital TV, comprising the steps of:
judging whether an input signal for image transmission exists from a user or not;
connecting the digital TV and the external device to each other by wireless if there exists the input signal for the image transmission;
transmitting the image stored in the digital TV to the external device through the wireless communication module of the digital TV;
judging whether the image transmission is completed or not; and
releasing a wireless connection between the digital TV and the external device if the image transmission is completed.

19. The image service method of claim 18, wherein the step of displaying the stored images is repeated if the input signal for the image transmission fails to exist.

20. The image service method of claim 18, wherein the step of transmitting the image to the external device is repeated if the image transmission is not completed.
